(19) United States
(12) Patent Application Publication
(10) Pub. No.: US 2015/0326875 A1
(43) Pub. Date: Nov. 12, 2015

(54) VIDEO PROCESSING METHOD FOR DETERMINING POSITION OF REFERENCE BLOCK OF RESIZED REFERENCE FRAME AND RELATED VIDEO PROCESSING APPARATUS

(71) Applicant: MEDIATEK INC., Hsin-Chu (TW)

(72) Inventors: Chun-Chia Chen, Hsinchu City (TW); Yung-Chang Chang, New Taipei City (TW)

(21) Appl. No.: 14/704,980

(22) Filed: May 6, 2015

Related U.S. Application Data
(60) Provisional application No. 61/989,051, filed on May 6, 2014.

(51) Int. Cl. H04N 19/52; H04N 19/56; H04N 19/59; H04N 19/33

(52) U.S. Cl. CPC H04N 19/52; H04N 19/33; H04N 19/56; H04N 19/59

(57) ABSTRACT

A video processing method includes: receiving a motion vector of a prediction block in a current frame; performing a first motion vector scaling operation upon the motion vector to generate a first scaled motion vector; after the first scaled motion vector is generated, utilizing a motion vector clamping circuit for performing a first motion vector clamping operation upon the first scaled motion vector to generate a first clamped motion vector; and determining a position of a reference block of a reference frame according to at least the first clamped motion vector.

### CROSS REFERENCE TO RELATED APPLICATIONS

This application claims the benefit of U.S. provisional application No. 61/989,051, filed on May 6, 2014 and incorporated herein by reference.

### BACKGROUND

The present invention relates to video encoding/decoding, and more particularly, to a video processing method for determining a position of a reference block of a resized reference frame and a related video processing apparatus.

Successive video frames may contain the same objects (still objects or moving objects). Motion estimation can examine the movement of objects in a video sequence composed of successive video frames to try to obtain vectors representing the estimated motion. Motion compensation can use the knowledge of object motion obtained by motion estimation to achieve frame data compression/decompression. In inter-frame coding, motion estimation and motion compensation have become powerful techniques to eliminate the temporal redundancy due to high correlation between consecutive video frames.

With regard to a typical coding algorithm, a frame dimension of a current frame is the same as a frame dimension of a reference frame (e.g., a reconstructed frame at the encoder side or a decoded frame at the decoder side). That is, the current frame and the reference frame have the same width and the same height. Hence, a motion vector of a prediction block in the current frame can be directly used to locate a reference block in the reference block for motion compensation. However, with regard to a newly-developed coding algorithm, it may allow the frame resolution to be changed on-the-fly. Hence, the reference frame may be resized to have a resolution different from a resolution of the current frame. Due to discrepancy between frame dimensions of the current frame and the resized reference frame, a motion vector of a prediction block in the current frame cannot be directly used to locate a reference block in the resized reference frame for motion compensation.

Thus, there is a need for an innovative design which is capable of accurately determining a position of a reference block of a reference frame having a frame dimension different from that of a current frame.

### SUMMARY

One of the objectives of the claimed invention is to provide a video processing method for determining a position of a reference block of a resized reference frame and a related video processing apparatus.

According to a first aspect of the present invention, an exemplary video processing method is disclosed. The exemplary video processing method includes: receiving a motion vector of a prediction block in a current frame; performing a first motion vector scaling operation upon the motion vector to generate a first scaled motion vector; after the first scaled motion vector is generated, utilizing a motion vector clamping circuit for performing a first motion vector clamping operation upon the first scaled motion vector to generate a first clamped motion vector; and determining a position of a reference block of a reference frame according to at least the first clamped motion vector.

According to a second aspect of the present invention, an exemplary video processing apparatus is disclosed. The exemplary video processing apparatus includes a receiving circuit, a motion vector scaling circuit, a motion vector clamping circuit, and a reference block position determining circuit. The receiving circuit is arranged to receive a motion vector of a prediction block in a current frame. The motion vector scaling circuit is arranged to perform a first motion vector scaling operation upon the motion vector to generate a first scaled motion vector. The motion vector clamping circuit is arranged to perform a first motion vector clamping operation upon the first scaled motion vector to generate a first clamped motion vector after the first scaled motion vector is generated. The reference block position determining circuit is arranged to determine a position of a reference block of a reference frame according to at least the first clamped motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a video processing apparatus according to an embodiment of the present invention.

FIG. 2 is a diagram illustrating an example of determining a position of a reference block of a resized reference frame.

FIG. 3 is a flowchart illustrating a video processing method according to an embodiment of the present invention.

FIG. 4 is a block diagram illustrating another video processing apparatus according to an embodiment of the present invention.

FIG. 5 is a diagram illustrating an example of determining a position of a reference block of a resized reference frame when a second mode is enabled.

FIG. 6 is a flowchart illustrating another video processing method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

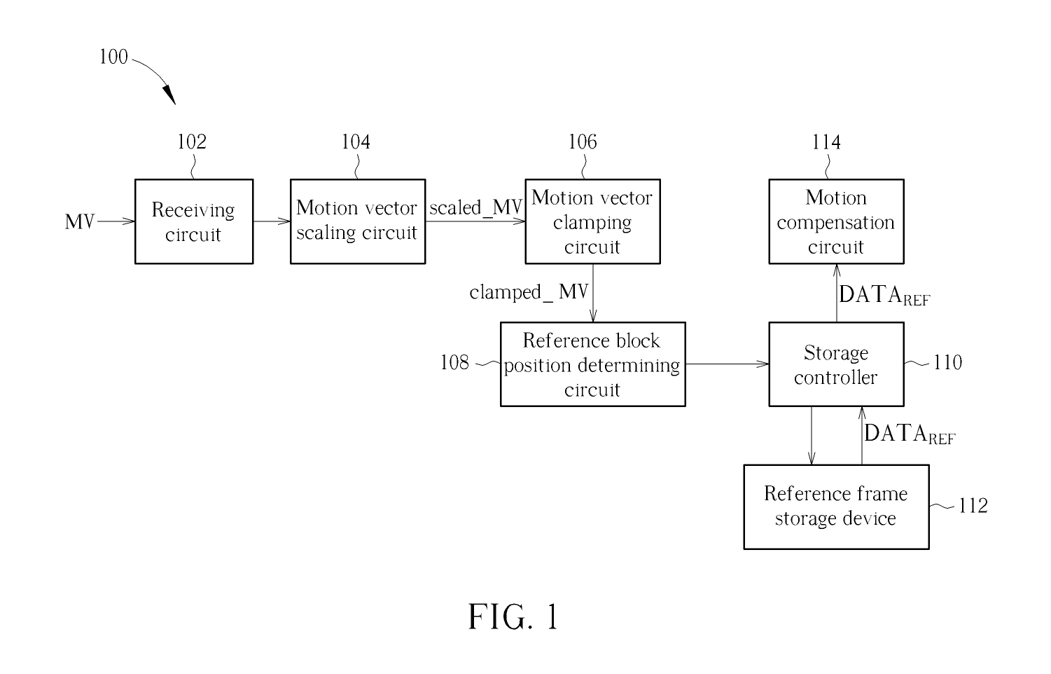

FIG. 1 is a block diagram illustrating a video processing apparatus according to an embodiment of the present invention. In one application, the video processing apparatus 100 may be part of a video encoder used to perform a video encoding procedure compliant with a video coding standard such as VP9. In another application, the video processing apparatus 100 may be part of a video decoder used to perform a video decoding procedure compliant with a video coding standard such as VP9. In accordance with the VP9 video coding standard, the RRF (Resolution Reference Frames) feature is a technique which allows a frame size to change on-the-fly inside a VP9 video bitstream. Hence, there may be a discrepancy between frame dimensions of a current frame (e.g., a video frame currently being encoded at the encoder side or a video frame currently being decoded at the decoder side) and a reference frame (e.g., a resized reconstructed frame serving as a reference frame at the encoder side or a resized decoded frame serving as a reference frame at the decoder side). The proposed video processing apparatus 100 is capable of accurately determining a position of a reference block of the reference frame (i.e., resized reference frame) having a frame dimension different from that of the current frame.

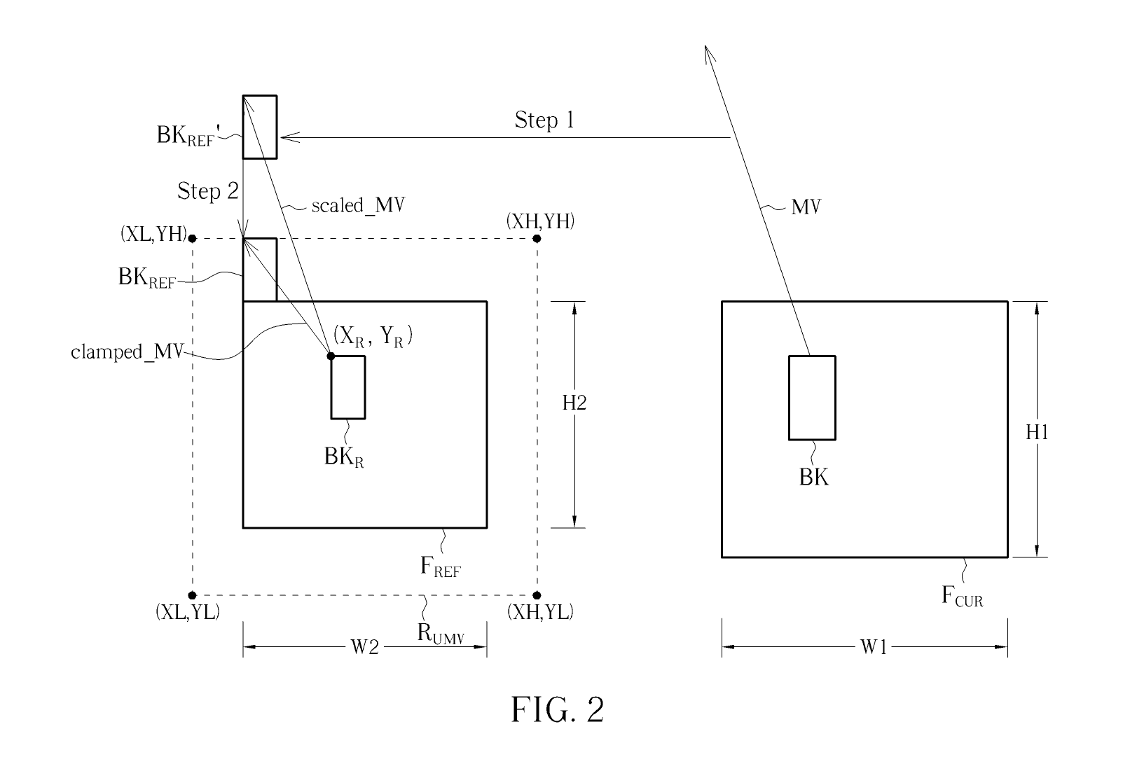

Please refer to FIG. 1 in conjunction with FIG. 2. FIG. 2 is a diagram illustrating an example of determining a position of a reference block of a resized reference frame. As shown in FIG. 1, the proposed video processing apparatus 100 includes a receiving circuit 102, a motion vector scaling circuit 104, a motion vector clamping circuit 106, a reference block position determining circuit 108, a storage controller 110, a reference frame storage device 112, and a motion compensation circuit 114. The receiving circuit 102 is arranged to receive a motion vector MV of a prediction block BK in a current frame F_{CUR} being encoded/decoded, where the motion vector MV may be generated by motion estimation. The receiving circuit 102 is coupled to the motion vector scaling circuit 104, and is further arranged to transmit the received motion vector MV to the motion vector scaling circuit 104 for further processing.

The motion vector scaling circuit 104 is arranged to perform a motion vector scaling operation upon the motion vector MV to generate a scaled motion vector scaled_MV. Specifically, a frame dimension (width W2, height H2) of a reference frame F_{REF} is different from a frame dimension (width W1, height H1) of the current frame F_{CUR}. In other words, W2≠W1 and/or H2≠H1. Hence, the motion vector scaling circuit 104 scales the motion vector MV in a current frame domain to the scaled motion vector scaled_MV in a reference frame domain based on a ratio of the frame dimension of the reference frame F_{REF} to the frame dimension of the current frame F_{CUR}. The motion vector MV can be decomposed into a vector mv_x in the X direction and a vector mv_y in the Y direction. Similarly, the scaled motion vector scaled_MV can be decomposed into a vector scaled_mv_x in the X direction and a vector scaled_mv_y in the Y direction. The motion vector scaling operation scale_mv ( ) applied to the motion vector MV (MV=(mv_x, mv_y)) may be expressed as below.

$$scale\_mv ( M V )$$

$$\{ \begin{matrix}scaled\_mv \_x = \frac{W 2}{W 1} * mv\_x \\ scaled\_mv \_y = \frac{H 2}{H 1} * mv\_y\end{matrix} \} \\$$

The above formula for calculating a scaled motion vector scaled_MV, including a vector scaled_mv_x in the X direction and a vector scaled_mv_y in the Y direction, is for illustrative purposes only, and is not meant to be a limitation of the present invention. In practice, with regard to a different video coding standard, a different formula for calculating a scaled motion vector scaled_MV may be employed by the motion vector scaling circuit 104. This also falls within the scope of the present invention.

It should be noted that the prediction block BK in the current frame domain is scaled into a prediction block (e.g., BK_{R}) in the reference frame domain based on the same ratio of the frame dimension of the reference frame F_{REF} to the frame dimension of the current frame F_{CUR}. In other words, due to reference frame resizing, the block dimension of the prediction block in the reference frame domain is different from the block dimension of the prediction block BK in the current frame domain.

In an unrestricted motion vector (UMV) mode, motion vectors are allowed to point outside the frame area, thus enabling a much better prediction, particularly when a reference block is partly located outside the frame area and part of it is not available for prediction. Those unavailable pixels can be predicted using boundary pixels (i.e., edge pixels) of the frame instead. As shown in FIG. 2, there is a UMV repeated region R_{UMV} extended from the reference frame F_{REF} by repeating boundary pixels (i.e., edge pixels) of the reference frame F_{REF}. In this embodiment, the UMV repeated region R_{UMV} is treated as a motion vector clamping region since a reference block in the reference frame domain is required to be located inside the boundary of the UMV repeated region R_{UMV}.

In this embodiment, a reference block BK_{REF}′ pointed to by the scaled motion vector scaled_MV is not fully inside the boundary of the motion vector clamping region R_{UMV} extended from the reference frame F_{REF}. Hence, the motion vector clamping circuit 106 is arranged to perform a motion vector clamping operation upon the scaled motion vector scaled_MV to generate a clamped motion vector clamped_MV after the scaled motion vector scaled_MV is generated from the motion vector scaling circuit 104 to the motion vector clamping circuit 106, where the reference block BK_{REF} pointed to by the clamped motion vector clamped_MV is fully inside the boundary of the motion vector clamping region R_{UMV} extended from the reference frame F_{REF}. The clamped motion vector clamped_MV can be decomposed into a vector clamped_mv_x in the X direction and a vector clamped_mv_y in the Y direction. The motion vector clamping operation mv_clamp ( ) applied to the scaled motion vector scaled_MV (scaled_MV=(scaled_mv_x, scaled_mv_y)) may be expressed as below.

mv_clamp (scaled_MV)
{
if a reference block pointed to by the scaled motion vector

scaled_MV is fully inside the boundary of the motion vector
clamping region R_{UMV},
keep the scaled motion vector scaled_MV unchanged

else

the scaled motion vector scaled_MV is clamped so as to make
a reference block pointed to by the clamped motion vector
clamped_MV be fully inside the boundary of the motion vector
clamping region R_{UMV}

}

Since the frame dimension of the reference frame F_{REF} is different from the frame dimension of the current frame F_{CUR}, the prediction block BK in the current frame domain may be scaled into a prediction block in the reference frame domain. When the original scaled prediction block in the reference frame F_{REF} is located at an integer pixel position, the original scaled prediction block will be treated as the illustrated prediction block BK_{R} located at (X_{R}, Y_{R}) with integer-pel precision. However, when the original scaled prediction block in the reference frame F_{REF} is located at a fractional pixel position, the original scaled prediction block plus an additional pixel area (which is needed for fractional-pel interpolation) will be treated as the illustrated prediction block BK_{R} located at (X_{R}, Y_{R}) with integer-pel precision.

Specifically, the clamped motion vector clamped_MV can be decomposed into a vector clamped_mv_x in the X direction and a vector clamped_mv_y in the Y direction. The motion vector clamping region R_{UMV} has a lower boundary value XL and an upper boundary value XH in the X direction, and further has a lower boundary value YL and an upper boundary value YH in the Y direction. The prediction block BK_{R} is located at (X_{R}, Y_{R}) in the reference frame F_{REF}. The reference block BK_{REF}′ pointed to by the scaled motion vector scaled_MV is located at (X_{R}+scaled_mv_x, Y_{R}+scaled_mv_y) and is not fully inside the boundary of the motion vector clamping region R_{UMV}. In a first case where X_{R}+scaled_mv_x<XL, the vector scaled_mv_x is clamped to the vector clamped_mv_x so as to make X_{R}+clamped_mv_x=XL. In a second case where X_{R}+scaled_mv_x>XH, the vector scaled_mv_x is clamped to the vector clamped_mv_x so as to make X_{R}+clamped_mv_x=XH. However, if XL≦X_{R}+scaled_mv_x≦XH, the vector scaled_mv_x is kept unchanged, thus leading to clamped_mv_x=scaled_mv_x. In a third case where Y_{R}+scaled_mv_y<YL, the vector scaled_mv_y is clamped to the vector clamped_mv_y so as to make Y_{R}+clamped_mv_y=YL. In a fourth case where Y_{R}+scaled_mv_y>YH, the vector scaled_mv_y is clamped to the vector clamped_mv_y so as to make Y_{R}+clamped_mv_y=YH. However, if YL≦Y_{R}+scaled_mv_y≦YH, the vector scaled_mv_y is kept unchanged, thus leading to clamped_mv_y=scaled_mv_y.

As shown in FIG. 2, the reference block BK_{REF}′ pointed to by the scaled motion vector scaled_MV is not fully inside the boundary of the motion vector clamping region R_{UMV}. After the scaled motion vector scaled_MV is processed by the motion vector clamping circuit 106 to restrict the scaled motion vector scaled_MV to the motion vector clamping region R_{UMV}, the reference block position determining circuit 108 is arranged to determine a position of the reference block BK_{REF} of the reference frame F_{REF} according to at least the clamped motion vector clamped_MV. For example, the reference block position determining circuit 108 may calculate (X_{R}+clamped_mv_x, Y_{R}+clamped_mv_y) to determine the position of the reference block BK_{REF} in the reference frame domain.

The storage controller (e.g., a memory controller) 110 is coupled to the reference block position determining circuit 108, the reference frame storage device (e.g., a dynamic random access memory) 112 and the motion compensation circuit 114. The storage controller 110 is arranged to retrieve pixel data DATA_{REF} of the reference block BK_{REF} from the reference frame storage device 112 according to the position of the reference block BK_{REF} of the reference frame F_{REF}, and transmit the retrieved pixel data DATA_{REF} of the reference block BK_{REF} to the motion compensation circuit 114. The motion compensation circuit 114 is arranged to perform motion compensation according to the retrieved pixel data DATA_{REF} of the reference block BK_{REF}. Since the frame dimensions of the current frame F_{CUR} and F_{REF} are different from each other, the motion compensation circuit 114 may further perform pixel interpolation upon retrieved pixel data DATA_{REF} of the reference block BK_{REF}.

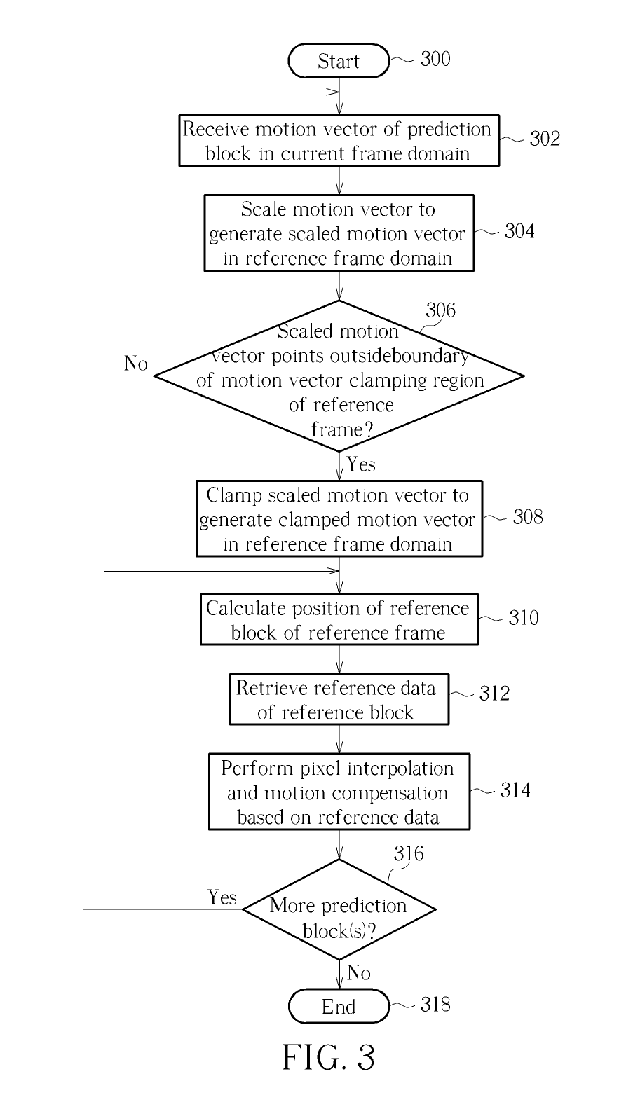

FIG. 3 is a flowchart illustrating a video processing method according to an embodiment of the present invention. Provided that the result is substantially the same, the steps are not required to be executed in the exact order shown in FIG. 3. The video processing method may be employed by the video processing apparatus 100, and may be briefly summarized as below.

Step 300: Start.

Step 302: Receive a motion vector of a prediction block in a current frame domain.

Step 304: Scale the motion vector to generate a scaled motion vector in a reference frame domain.

Step 306: Check if the scaled motion vector points outside a boundary of a motion vector clamping region extending from a reference frame. If yes, go to step 308; otherwise, go to step 310.

Step 308: Clamp the scaled motion vector to generate a clamped motion vector in the reference frame domain.

Step 310: Calculate a position of a reference block of a reference frame.

Step 312: Retrieve pixel data (i.e., reference data) of the reference block from a reference frame storage device (i.e., a reference frame buffer).

Step 314: Perform pixel interpolation and motion compensation based on the retrieved pixel data.

Step 316: Check if there are more prediction blocks in the current frame to be encoded/decoded. If yes, go to step 302; otherwise, go to step 318.

Step 318: End.

As a person skilled in the art can readily understand details of each step shown in FIG. 3 after reading above paragraphs, further description is omitted for brevity.

In a case where a reference frame is resized to have a resolution different from that of a current frame being encoded/decoded, the motion vector clamping operation (Step 2) may be performed after the motion vector scaling operation (Step 1). Alternatively, the proposed video processing apparatus 100 may be modified to support a first mode and a second mode. When the first mode is enabled, the motion vector clamping operation (Step 2) is performed after the motion vector scaling operation (Step 1). However, when the second mode is enabled, the motion vector clamping operation (Step 1) is performed before the motion vector scaling operation (Step 2). Different execution orders of motion vector scaling operation and motion vector clamping operation may result in different accuracy of the reference block position in the reference frame domain. Compared to a final motion vector determined under the second mode, a final motion vector determined under the first mode is more accurate, thus leading to better image quality. The first mode and the second mode may co-exist in the same video encoder or the same video decoder, and one of the first mode and the second mode may be enabled, depending upon the actual application requirement.

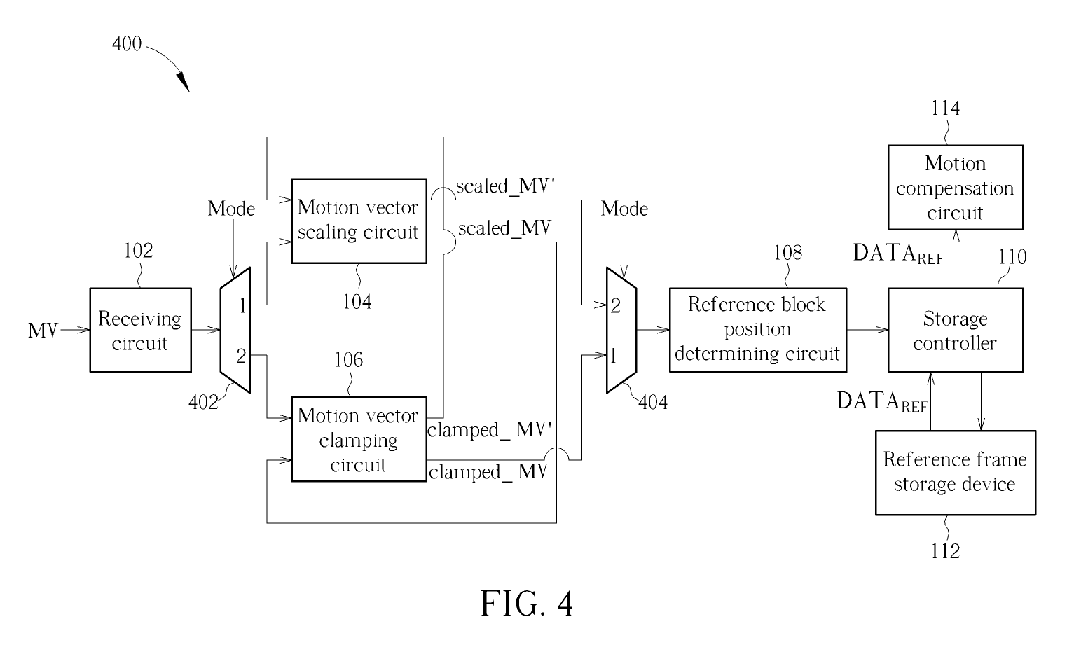

FIG. 4 is a block diagram illustrating another video processing apparatus according to an embodiment of the present invention. In one application, the video processing apparatus 400 may be part of a video encoder used to perform a video encoding procedure compliant with a video coding standard such as VP9. In another application, the video processing apparatus 400 may be part of a video decoder used to perform a video decoding procedure compliant with a video coding standard such as VP9. The major difference between the video processing apparatuses 100 and 400 is that the video processing apparatus 400 supports the first mode and the second mode, while the video processing apparatus 100 supports the first mode only. As shown in FIG. 4, the video processing apparatus 400 includes a demultiplexer 402 and a multiplexer 404 both controlled based on the mode selection.

When the first mode is enabled, the demultiplexer 402 transmits the motion vector MV received by the receiving circuit 102 to the motion vector scaling circuit 104, the scaled motion vector scaled_MV is generated from the motion vector scaling circuit 104 to the motion vector clamping circuit 106, and the multiplexer 404 transmits the clamped motion vector clamped_MV generated from the motion vector clamping circuit 106 to the reference block position determining circuit 108. Hence, the reference block position determining circuit 108 determines a position of a reference block in the reference frame domain based on at least the clamped motion vector clamped_MV. Since details of the first mode are already described above, further description is omitted here for brevity.

When the second mode is enabled, the demultiplexer 402 transmits the motion vector MV received by the receiving circuit 102 to the motion vector clamping circuit 106, the clamped motion vector scaled_MV′ is generated from the motion vector clamping circuit 106 to the motion vector scaling circuit 104, and the multiplexer 404 transmits the scaled motion vector scaled_MV′ generated from the motion vector scaling circuit 104 to the reference block position determining circuit 108. Hence, the reference block position determining circuit 108 determines a position of a reference block in the reference frame domain based on at least the scaled motion vector scaled_MV′. Details of the second mode are described as below.

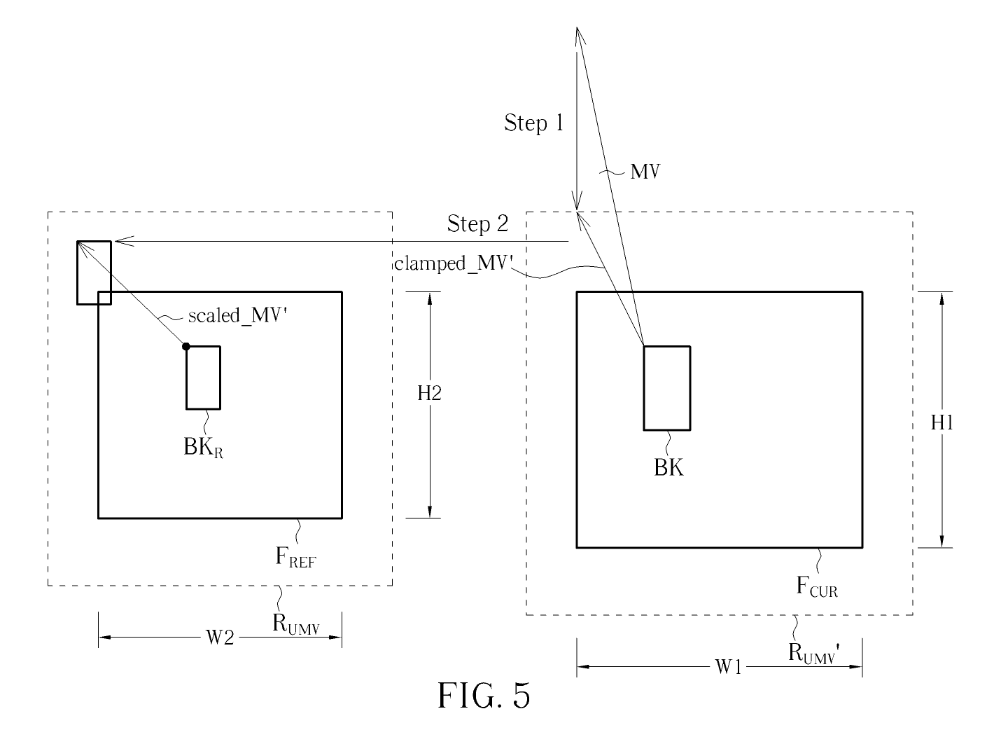

Please refer to FIG. 4 in conjunction with FIG. 5. FIG. 5 is a diagram illustrating an example of determining a position of a reference block of a reference frame when the second mode is enabled. The receiving circuit 102 receives a motion vector MV of a prediction block BK in a current frame F_{CUR}, and transmits the received motion vector MV to the motion vector clamping circuit 106. As shown in FIG. 5, there is a UMV repeated region R_{UMV}′ extended from the current frame F_{CUR} by repeating boundary pixels (i.e., edge pixels) of the current frame F_{CUR}. In this embodiment, the UMV repeated region R_{UMV}′ is treated as a motion vector clamping region. Since the motion vector MV points outside the boundary of the motion vector clamping region R_{UMV}′, the motion vector clamping circuit 106 in the second mode is arranged to perform a motion vector clamping operation upon the motion vector MV to generate a clamped motion vector clamped_MV′, where the clamped motion vector clamped_MV′ is restricted to the motion vector clamping region R_{UMV}′. If the motion vector MV points inside the boundary of the motion vector clamping region R_{UMV}′, the motion vector clamping circuit 106 keeps the motion vector MV unchanged (i.e., clamped_MV′=MV). Since the rule of setting the clamped motion vector clamped_MV′ based on an input motion vector is similar to the rule of setting the clamped motion vector clamped_MV based on an input motion vector, further description is omitted here for brevity.

In the second mode, the motion vector scaling circuit 104 is arranged to perform a motion vector scaling operation upon the clamped motion vector clamped_MV to generate a scaled motion vector scaled_MV′. Specifically, a frame dimension (width W2, height H2) of the reference frame F_{REF} is different from a frame dimension (width W1, height H1) of the current frame F_{CUR}, where W2≠W1 and/or H2≠H1. Hence, the motion vector scaling circuit 104 scales the clamped motion vector clamped_MV in a current frame domain to the scaled motion vector scaled_MV′ in a reference frame domain based on a ratio of the frame dimension of the reference frame F_{REF} to the frame dimension of the current frame F_{CUR}. Since the rule of setting the scaled motion vector clamped_MV based on an input motion vector is similar to the rule of setting the scaled motion vector clamped_MV based on an input motion vector, further description is omitted here for brevity. In this example shown in FIG. 5, a reference block pointed to by the scaled motion vector scaled_MV′ is not fully within the ring-shaded motion vector clamping region R_{UMV}, and is less accurate compared to a reference block pointed to by the clamped motion vector clamped_MV as shown in FIG. 2. However, this is for illustrative purposes only, and is not meant to be a limitation of the present invention.

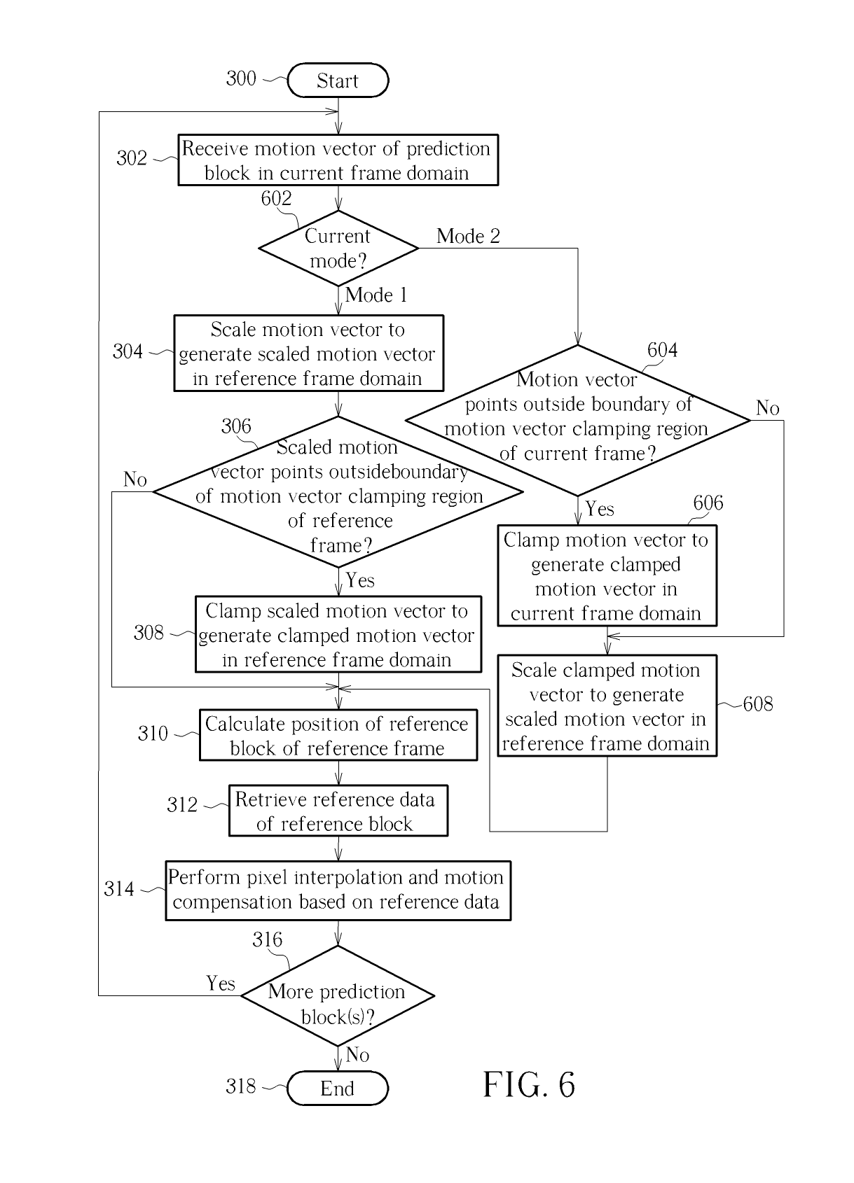

FIG. 6 is a flowchart illustrating another video processing method according to an embodiment of the present invention. Provided that the result is substantially the same, the steps are not required to be executed in the exact order shown in FIG. 6. The video processing method may be employed by the video processing apparatus 400. The major difference between the video processing methods shown in FIG. 3 and FIG. 6 is that the video processing method in FIG. 6 supports two modes and further includes steps 602-608 as below.

Step 602: Check a current mode.

Step 604: Check if the motion vector points outside a boundary of a motion vector clamping region extending from a current frame. If yes, go to step 606; otherwise, go to step 608.

Step 606: Clamp the motion vector to generate a clamped motion vector in the current frame domain.

Step 608: Scale the clamped motion vector to generate a scaled motion vector in a reference frame domain.

As a person skilled in the art can readily understand details of each step shown in FIG. 6 after reading above paragraphs, further description is omitted for brevity.

In above embodiments, a reference block located using the proposed method is referenced for motion compensation. However, this is not meant to be a limitation of the present invention. Any application using the proposed method to determine a position of a reference block in a reference frame based on motion vector scaling (step 1) and motion vector clamping (step 2) falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing method comprising:
receiving a motion vector of a prediction block in a current frame;
performing a first motion vector scaling operation upon the motion vector to generate a first scaled motion vector;
after the first scaled motion vector is generated, utilizing a motion vector clamping circuit for performing a first motion vector clamping operation upon the first scaled motion vector to generate a first clamped motion vector; and
determining a position of a reference block of a reference frame according to at least the first clamped motion vector.

2. The video processing method of claim 1, wherein a frame dimension of the reference frame is different from a frame dimension of the current frame.

3. The video processing method of claim 2, wherein performing the first motion vector scaling operation upon the motion vector comprises:
scaling the motion vector in a current frame domain to the first scaled motion vector in a reference frame domain based on a ratio of the frame dimension of the reference frame to the frame dimension of the current frame.

4. The video processing method of claim 2, wherein a reference block pointed to by the first scaled motion vector is not fully inside a boundary of a motion vector clamping region extended from the reference frame; and the reference block pointed to by the first clamped motion vector is fully inside the boundary of the motion vector clamping region extended from the reference frame.

5. The video processing method of claim 4, wherein the motion vector clamping region is extended from the reference frame by repeating boundary pixels of the reference frame.

6. The video processing method of claim 1, further comprising:
retrieving pixel data of the reference block from a reference frame storage device according to the position of the reference block of the reference frame; and
performing motion compensation according to the retrieved pixel data of the reference block.

7. The video processing method of claim 1, wherein the video processing method is part of a video encoding procedure.

8. The video processing method of claim 1, wherein the video processing method is part of a video decoding procedure.

9. The video processing method of claim 1, further comprising:
selectively enabling one of a first mode and a second mode;
wherein when the first mode is enabled, steps of performing the first motion vector scaling operation upon the motion vector, performing the first motion vector clamping operation upon the first scaled motion vector, and determining the position of the reference block of the reference frame according to at least the first clamped motion vector are performed; and when the second mode is enabled, steps of performing a second motion vector clamping operation upon the motion vector to generate a second clamped motion vector, performing a second motion vector scaling operation upon the second clamped motion vector to generate a second scaled motion vector after the second clamped motion vector is generated, and determining the position of the reference block of the reference frame according to at least the second scaled motion vector are performed.

10. The video processing method of claim 9, wherein a frame dimension of the reference frame is different from a frame dimension of the current frame.

11. A video processing apparatus, comprising:
a receiving circuit, arranged to receive a motion vector of a prediction block in a current frame;
a motion vector scaling circuit, arranged to perform a first motion vector scaling operation upon the motion vector to generate a first scaled motion vector;
a motion vector clamping circuit, arranged to perform a first motion vector clamping operation upon the first scaled motion vector to generate a first clamped motion vector after the first scaled motion vector is generated; and
a reference block position determining circuit, arranged to determine a position of a reference block of a reference frame according to at least the first clamped motion vector.

12. The video processing apparatus of claim 11, wherein a frame dimension of the reference frame is different from a frame dimension of the current frame.

13. The video processing apparatus of claim 12, wherein the motion vector scaling circuit scales the motion vector in a current frame domain to the first scaled motion vector in a reference frame domain based on a ratio of the frame dimension of the reference frame to the frame dimension of the current frame.

14. The video processing apparatus of claim 12, wherein a reference block pointed to by the first scaled motion vector is not fully inside a boundary of a motion vector clamping region extended from the reference frame; and the reference block pointed to by the first clamped motion vector is fully inside the boundary of the motion vector clamping region extended from the reference frame.

15. The video processing apparatus of claim 14, wherein the motion vector clamping region is extended from the reference frame by repeating boundary pixels of the reference frame.

16. The video processing apparatus of claim 11, further comprising:
a storage controller, arranged to retrieve pixel data of the reference block from a reference frame storage device according to the position of the reference block of the reference frame; and
a motion compensation circuit, arranged to perform motion compensation according to the retrieved pixel data of the reference block.

17. The video processing apparatus of claim 11, wherein the video processing apparatus is part of a video encoder.

18. The video processing apparatus of claim 11, wherein the video processing apparatus is part of a video decoder.

19. The video processing apparatus of claim 11, wherein one of a first mode and a second mode is selectively enabled; when the first mode is enabled, the motion vector scaling circuit performs the first motion vector scaling operation, the motion vector clamping circuit performs the first motion vector clamping operation, and the reference block position determining circuit determines the position of the reference block of the reference frame according to at least the first clamped motion vector; and when the second mode is enabled, the motion vector clamping circuit performs a second motion vector clamping operation upon the motion vector to generate a second clamped motion vector, the motion vector scaling circuit performs a second motion vector scaling operation upon the second clamped motion vector to generate a second scaled motion vector after the second clamped motion vector is generated, and the reference block position determining circuit determines the position of the reference block of the reference frame according to at least the second scaled motion vector.

20. The video processing apparatus of claim 19, wherein a frame dimension of the reference frame is different from a frame dimension of the current frame.
